(19) United States
(12) Patent Application Publication
(10) Pub. No.: US 2013/0283537 A1
(43) Pub. Date: Oct. 31, 2013

(54) Quilted Mattress Panels with Gel Fibers and Mattresses Made with Same

(71) Applicant: ADVANCED SLEEP CONCEPTS, Rome, GA (US)

(72) Inventor: Dominick Azevedo, North Venice, FL (US)

(73) Assignee: Advanced Sleep Concepts, Rome, GA (US)

(21) Appl. No.: 13/870,688

(22) Filed: Apr. 25, 2013

Related U.S. Application Data
(60) Provisional application No. 61/638,226, filed on Apr. 25, 2012.
(60) Provisional application No. 61/784,348, filed on Mar. 14, 2013.

(51) Int. Cl. A47C 27/08; B32B 7/08; A47C 31/00

(52) U.S. Cl. CPC A47C 27/085; A47C 31/001; B32B 7/08
USPC 5/698; 5/690; 428/171

(57) ABSTRACT

A quilted panel for a mattress having gel fibers incorporated therein so as to bring the gel material closer to the top of the mattress such that the benefits of the gel material are better realized by the user. In some embodiments, the gel fibers are incorporated into the FR fiber pad of the quilted panel. In other embodiments, a separate gel fiber pad is positioned within the quilted panel.

### CROSS-REFERENCE TO RELATED APPLICATIONS

This application claims the benefit of U.S. Provisional Application No. 61/638,226, filed Apr. 25, 2012, and U.S. Provisional Application No. 61/784,348, filed Mar. 14, 2013, the entirety of each of which is herein incorporated by reference.

### FIELD

Embodiments of the present invention relate to quilted mattress panels containing gel fibers and mattresses having quilted mattress panels containing gel fibers.

### BACKGROUND

Mattresses often have the basic structure as depicted in FIG. 1. The mattress core 10 (e.g., springs, foam, air, water, etc.) is sandwiched between layers of foam 12. The mattress is topped with a quilted panel 14 that imparts the desired aesthetic appearance and comfort as well as the necessary flame resistant (“FR”) properties to the mattress.

The quilted panel 14 typically includes at least three layers quilted together, such as illustrated in FIG. 2. A fabric layer 16 forms the top of the quilted panel 14 and is visible from the outside of the mattress. A fiber pad 18 is located beneath the fabric 16. The fiber pad 18 is typically formed of a blend of polymeric fibers (e.g., polyester) with cellulosic fibers (e.g., rayon, cotton, etc.) that have been treated with a flame retardant so as to be flame resistant (either at the fiber stage or the pad stage). The fiber pad 18 thereby imparts the necessary FR properties to the mattress for compliance with 16 CFR Part 1633 (2006). The bottom of the quilted panel 14 includes a. bottom insulator layer 20, such as a fabric or felt material. During construction, the three layers of the quilted panel 14 are overlaid and quilted to attach them together and impart the desired aesthetic pattern the quilted panel fabric 16 visible on the outside of the mattress, in some embodiments, the quilted panel 14 also includes a foam layer or layers 22 interposed, between the fiber pad 18 and bottom insulator 20 to impart additional comfort to the mattress, as shown in FIG. 3.

Solid gel material (not gel fibers) has been included in mattresses to improve the durability of the mattress and provide additional support and comfort to the user. Because the gel material can “gum up” the quilting needles, the gel material has been included in portions of the mattress that are not subjected to quilting. For example, the gel material has been incorporated in the foam layer 12 positioned above the mattress core 10 and below the quilted panel 14. Holes have been provided in the foam layer 12 and gel poured and set in the holes. Alternatively, gel has been applied to all or a portion of the top surface of the foam layer 12.

### SUMMARY

Certain embodiments of the present invention provide a quilted panel for a mattress having gel fibers incorporated therein so as to bring the gel material closer to the top of the mattress such that the benefits of the gel material are better realized by the user. In some embodiments, the gel fibers are incorporated into the FR fiber pad of the quilted panel. In other embodiments, a separate gel fiber pad is positioned within the quilted panel.

The terms “invention,” “the invention,” “this invention” and “the present invention” used in this patent are intended to refer broadly to all of the subject matter of this patent and the patent claims below. Statements containing these terms should not be understood to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to the entire specification of this patent, all drawings and each claim.

### BRIEF DESCRIPTION OF THE FIGURES

Illustrative embodiments of the present invention are described in detail below with reference to the following drawing figures:

FIG. 1 is a cross-section of a prior art mattress.

FIG. 2 is a cross-section of a prior art quilted panel.

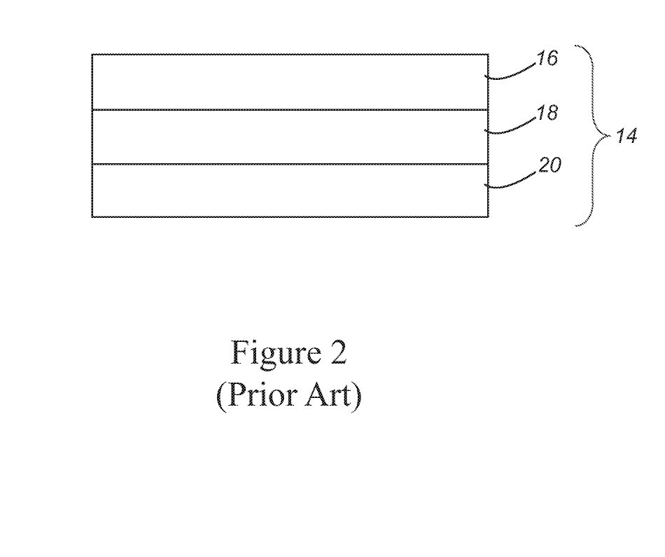

FIG. 3 is a cross-section of another prior art quilted panel.

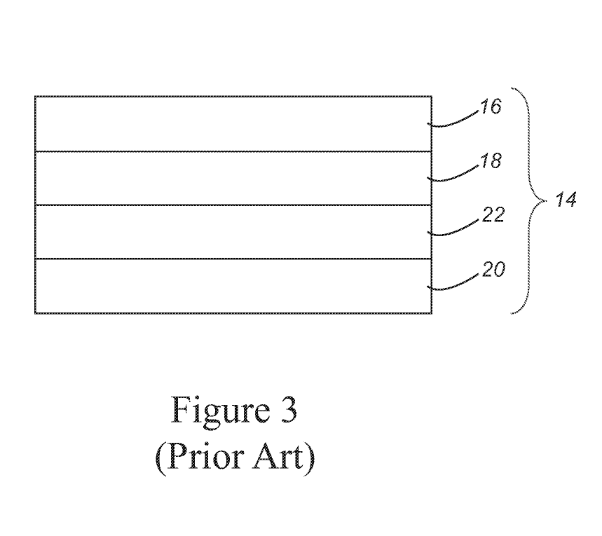

FIG. 4 is a cross-section of a quilted panel according to one embodiment.

FIG. 5 is a cross-section of a quilted panel according to another embodiment.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used. in conjunction with other existing or future technologies. This description should not be interpreted as implying any particular order or arrangement among or between various steps or elements except when the order of individual steps or arrangement of elements is explicitly described. For simplicity and unless otherwise indicated, like numerals are used to refer to the same layers of the mattress and quilted panel.

Embodiments of the invention bring the gel material closer to the top of the mattress such that the benefits of the gel material are better realized by the user. For example, embodiments of the invention incorporate gel fibers 15 into the quilted. panel 14 of the mattress. Gel fibers 15 include, but are not limited to, microgel fibers, including microgel polyester fibers (e.g., hollow slick gel spiral polyester fibers), such as those available from Louisville Bedding Company of Louisville, Ky.

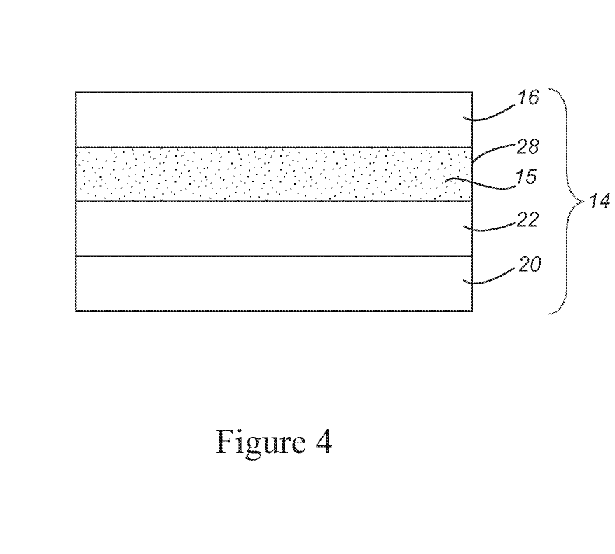

In some embodiments, the gel fibers 15 are incorporated into the FR fiber pad 18 of the quilted panel 14 to form a modified FR fiber pad 28 (see FIG. 4). The gel fibers 15 may be intimately blended with the fibers traditionally used to form the FR fiber pad 18 (e.g., polymeric fibers, cellulosic fibers, etc.) and then heat set or adhered together with a binder to form the modified FR fiber pad 28. After the FR fiber pad 28 is formed, it may be treated so as to render it FR or, alternatively, some or all of the fibers forming the FR fiber pad 28 may be so treated prior to pad formation.

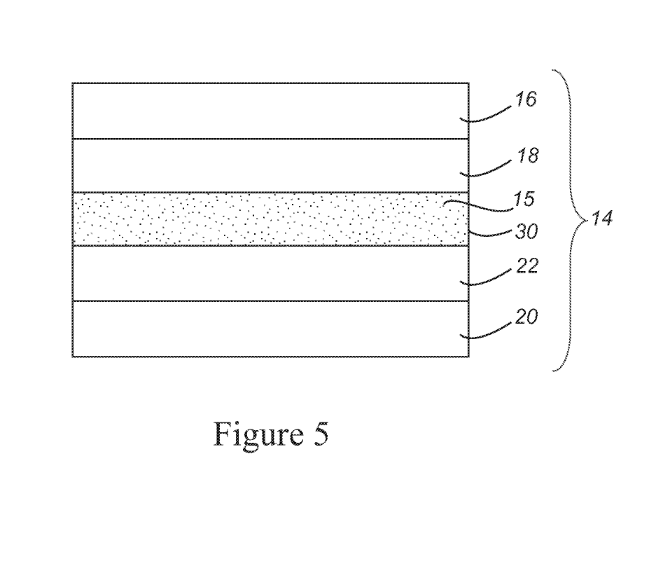

In another embodiment, a separate gel fiber pad 30 (see FIG. 5) is positioned within the quilted panel 14. For example, FIG. 5 illustrates the gel fiber pad 30 interposed between the FR fiber pad 18 and the optional foam layer 22 of the quilted panel 14. However, it could be positioned in other locations within the quilted panel 14 (e.g., between the fabric layer 16 and FR fiber pad 18 or between the FR fiber pad 18 and bottom layer 20, etc.), The gel fiber pad 30 can be formed of 100% gel fibers 15 fused or otherwise adhered together, such as with a binder. However, in other embodiments, the gel fiber pad 30 is formed of an intimate blend of gel fibers 15 and non-gel fibers (not illustrated) to form the gel fiber pad 30. By way only of example, the gel fibers 15 may be mixed with various polymeric fibers, including, but not limited to, polyester fibers, as well as with cellulosic fibers. In some embodiment, the gel fibers form between 5-100%, between 20-90%, between 40-85%, or between 50-80%, inclusive, of the gel fiber pad 30 blend. In one non-limiting example, the gel fiber pad 30 comprises 73% hollow slick gel spiral polyester fibers, 17% 4 denier 2″ low melt polyester fibers, and 10% 15 denier polyester fibers. The gel fiber pad 30 may include FR fibers or otherwise be treated with a flame retardant (such as by coating the gel fiber pad 30 in a FR solution); however, it may be unnecessary if the FR fiber pad 18 is designed to impart the necessary FR properties to the quilted panel 14.

In other embodiments, gel fibers 15 may be incorporated in other layers of the quilted panel 14. For example, the gel fibers could be interspersed or otherwise provided within the foam layer 22 of the quilted panel 14.

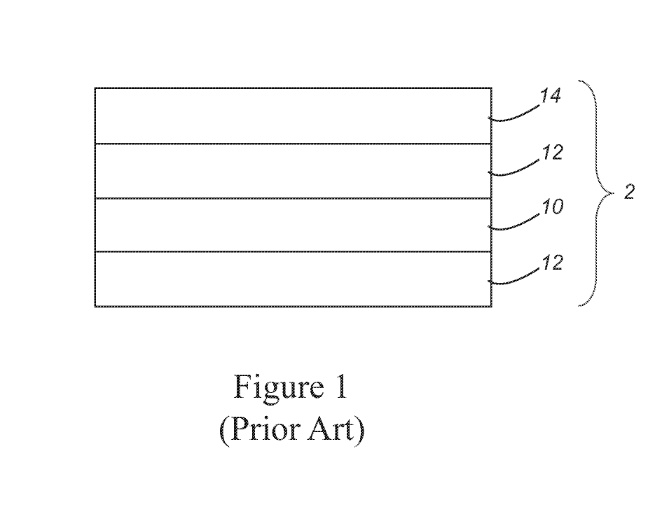

It should be understood that the quilted panels 14 disclosed in this detailed description could ultimately be positioned and attached to a mattress, such as one having the construction shown in FIG. 1 by way only of example.

The foregoing is provided for purposes of illustrating, explaining, and describing embodiments of the present invention. Further modifications and adaptations to these embodiments will be apparent to those skilled in the art and may be made without departing from the scope or spirit of the invention. Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the invention.

I claim:

1. A quilted panel comprising:
a. a top fabric laver; and
b. a fiber pad located below the top fabric laver, wherein the fiber pad comprises a fiber blend and wherein the fiber blend comprises gel fibers, wherein the top fabric layer and the fiber pad are quilted together.

2. The quilted panel of claim 1, wherein the fiber blend further comprises polymeric fibers.

3. The quilted panel of claim 2, wherein the polymeric fibers comprise polyester fibers.

4. The quilted panel of claim 2, wherein the fiber blend further comprises cellulosic fibers.

5. The quilted panel of claim 1, wherein the gel fibers comprise between 5-100%, inclusive, of the fiber blend.

6. The quilted panel of claim 5, wherein the gel fibers comprise between 20-90% inclusive, of the fiber blend.

7. The quilted panel of claim 6, wherein the gel fibers comprise between 40-85% inclusive, of the fiber blend.

8. The quilted panel of claim 7, wherein the gel fibers comprise between 50-80% inclusive, of the fiber blend.

9. The quilted panel of claim 1,, wherein the fiber pad comprises a flame retardant.

10. The quilted panel of claim 1, further comprising a flame resistant pad quilted with the top fabric layer and the fiber pad.

11. The quilted panel of claim 10, wherein the flame resistant pad is positioned between the top fabric layer and the fiber pad.

12. The quilted panel of claim 1, further comprising a foam layer quilted with the top fabric layer and the fiber pad.

13. The quilted panel of claim 1, further comprising a bottom insulation layer located below the fiber pad, wherein the bottom insulation layer is quilted with the top fabric layer and the fiber pad.

14. A mattress comprising the quilted panel of claim 1.

15. A quilted panel comprising:
a. a top fabric layer;
b. a flame resistant pad positioned below the top fabric layer;
c. a gel fiber pad located below the flame resistant pad, wherein the gel fiber pad comprises a fiber blend and wherein between 5-100%, inclusive, of the fiber blend comprises gel fibers; and
d. a bottom insulation layer located below the gel pad,
wherein the top fabric layer, the flame resistant pad, the gel fiber pad, and the bottom insulation layer are quilted together.

16. The quilted panel of claim 15, further comprising a foam layer quilted with the top fabric layer, the flame resistant pad, the gel fiber pad, and the bottom insulation laver.

17. A mattress comprising:
a. a core;
b. at least one foam layer; and
c. a quilted panel positioned above the at least one foam aver, wherein the quilted panel comprises:
(i) a top fabric layer visible on the mattress;
a flame resistant pad positioned below the top fabric layer; and
(iii) a gel fiber pad located below the flame resistant pad, wherein the gel fiber pad comprises a fiber blend and wherein between 5-100%, inclusive, of the fiber blend comprises gel fibers, wherein the top fabric layer, the flame resistant pad, and the gel fiber pad are quilted together.

18. The mattress of claim 17, wherein the quilted panel further comprises a foam layer quilted with the top fabric laver, the flame resistant pad, and the gel fiber pad.

19. The mattress of claim 17, wherein the quilted panel further comprises a bottom insulation layer quilted with the top fabric layer, the flame resistant pad, and the gel fiber pad.
